(19) United States
(12) Patent Application Publication
(10) Pub. No.: US 2004/0055111 A1
(43) Pub. Date: Mar. 25, 2004

(54) Door bearing and method of mounting a door

(76) Inventors: Hans-Frieder Eberhardt, Giengen-Burgberg (DE); Rudolf Schmidt, Giengen (DE); Jorg Stelzer, Giengen/Brenz (DE); Udo Wenning, Giengen/Brenz (DE)

Correspondence Address: LERNER AND GREENBERG, P.A., POST OFFICE BOX 2480, HOLLYWOOD, FL, 33022-2480, US

(21) Appl. No.: 10/623,834

(22) Filed: Jul. 21, 2003

Related U.S. Application Data
(63) Continuation of application No. PCT/EP02/00345, filed on Jan. 15, 2002.

(30) Foreign Application Priority Data
Jan. 19, 2001 (DE) 101 02 442.8

(51) Int. Cl. E05D 11/04

(52) U.S. Cl. 16/275; 16/273

(57) ABSTRACT

A door bearing includes a supporting arm for fastening on a door frame and a bearing journal for introducing into a bore of a door. The supporting arm has a bore for accommodating a base portion of the bearing journal in a form-fitting manner. The base portion and the supporting arm are provided with latching elements for interlocking the bearing journal on the supporting arm.

### CROSS-REFERENCE TO RELATED APPLICATION

This application is a continuation of copending International Application No. PCT/EP02/00345, filed Jan. 15, 2002, which designated the United States and was not published in English.

### BACKGROUND OF THE INVENTION

### FIELD OF THE INVENTION

The present invention relates to a door bearing with a supporting arm for fastening on a door frame and a bearing journal for introducing into a bore of a door, the door bearing being provided, in particular, for use on doors of refrigerators, and to a method of mounting a door, which can be implemented, in particular, using the door bearing.

The doors of refrigerators and the bearings thereof are generally configured such that, without it being necessary for parts to be exchanged, they are suitable for suspending a door with its hinges optionally on the right or left. This makes it possible for the manufacturer of the refrigerators to produce standardized doors and bearings, in which case it is only when the refrigerator is being set up for the user that the decision has to be made as to the position of the door hinges, it also being possible, if appropriate, for such a decision to be revised subsequently.

Conventional door bearings generally include a supporting arm made of metal, which may be punched, for example, out of a thick metal plate and to which a likewise metallic, cylindrical bearing journal is welded. To mount a door manually using such door bearings, the general practice, in the first instance, will be to fasten the bottom supporting bearing on the door frame of the refrigerator, to fit the door over the bearing journal of the bottom door bearing, by way of a bore provided for such a purpose, to insert the bearing journal into a corresponding bore on the top border of the door, and, finally, to fasten the top door bearing on the door frame. If the door tilts during such a procedure, this may result in damage to the bottom door bearing and, in particular, to the bottom bore of the door. The operations of mounting the door and of changing over the door hinges are, thus, not easy for unskilled individuals to carry out and involve a certain amount of risk.

### SUMMARY OF THE INVENTION

It is accordingly an object of the invention to provide a door bearing and method of mounting a door that overcome the hereinafore-mentioned disadvantages of the heretofore-known devices and methods of this general type and that by which even unskilled individuals can easily mount a door or change over its hinges.

With the foregoing and other objects in view, there is provided, in accordance with the invention, a door bearing for a door having a door frame and defining a door bore, the door bearing including a bearing journal to be introduced into the door bore, the bearing journal having a base portion, a supporting arm to be fastened to the door frame, the supporting arm defining a bore accommodating the base portion in a form-fitting manner, and the base portion and the supporting arm having latching elements interlocking the bearing journal on the supporting arm.

According to the invention, the supporting arm has a bore for accommodating a base portion of the bearing journal in a form-fitting manner, and the base portion and supporting arm are provided with latching elements for interlocking the bearing journal on the supporting arm. A door bearing so configured makes it possible, for the purpose of mounting the door, first of all, merely to fit the supporting arms on the door frame. As soon as the fitting has been done, an individual can hold the door in a suitable position between the supporting arms. As a result, the bearing journals can be pushed through the bores of the door bearing into the bores of the door and latched. The operations of pushing in the bearing journals and latching them only takes up a short amount of time. As a result, the risk of the door tilting in a non-intended manner during this time is relatively low. In particular, it is possible for the bearing journals to be pushed in while the door is held in abutment against the door frame, whereas, in the case of the conventional method described above, the door usually has to be secured in the open position in order to free the access that is necessary for fastening the top door bearing on the door frame.

It is also conceivable for the bearing journal of the top door bearing to be latched in before the door is fitted. As a result, the top bore of the door, moving in an oblique direction from beneath, can be fitted over the top bearing journal and, then, once the door has its full surface area butting against the door frame, the bottom bearing journal is latched in.

In accordance with another feature of the invention, a first configuration of the door bearing provides that the latching elements include an edge on the supporting arm and a flexible clip with a leg that can be moved away from the base portion when the base portion is pushed into the bore of the supporting arm and that bears a nose for engaging behind the edge. To allow subsequent release of the bearing journal, for example, for changing over the door hinges, the supporting arm and the leg are, preferably, formed such that a tool for releasing the nose from the edge can be introduced between the leg and the supporting arm.

As a result of another configuration, in accordance with a further feature of the invention, the latching elements include at least one cutout on the bore and at least one leg of the base portion, which can be bent in the direction of the axis of the bore of the supporting arm when the base portion is pushed into the bore and which bears a nose for engaging in the cutout. In such a configuration, it is preferred for the cutout only to extend over part of the circumference of the bore and for the base portion to be capable of being turned in the bore to displace the nose out of the cutout, i.e., turning the base portion causes the latching between the latter and the supporting arm to be released, and the supporting arm and bearing journal can be separated from one another.

To facilitate the turning action, it is preferable, in accordance with an added feature of the invention, at an end that is directed away from the bearing journal, for the base portion to have a cutout for accommodating a turning tool, for example, a screwdriver, a hexagon socket wrench, or the like, in a form-fitting manner.

In accordance with an additional feature of the invention, the bearing journal and the base portion may, advantageously, be formed in one piece from a plastic material, in particular, a fiber-reinforced plastic material. It is also quite possible, however, for the bearing journal to be of metal and the base portion to be of the plastic material, and for the two to be fixed together to form a single part.

In accordance with yet another feature of the invention, the supporting arm may also be formed from a plastic material, in particular, a fiber-reinforced plastic material.

To relieve the bearing journal of loading, in accordance with yet a further feature of the invention, a roller bearing is, preferably, disposed around the bearing journal to support the door. In the case of a bottom door bearing, this roller bearing is expediently an axial bearing. On account of its low overall height, a barrel-like roller bearing is preferred.

As is known, such a roller bearing is made up of two rings, which can be rotated in relation to one another with the aid of roller bodies disposed between them. According to a first configuration, in accordance with yet an added feature of the invention, each roller body is assigned a ramp-like ring portion. Such a configuration of the rings ensures that, as rotation of the door continues, the axial extent of the roller bearing increases and the door is raised. This effect may be utilized to subject the door to a restoring force in the direction of its closed state.

In accordance with again another feature of the invention, the number of roller bodies in the case of such a bearing is, preferably, limited to no more than three. This allows a rotary movement freedom of the door bearing of more or less 120°.

As an alternative to, or even in combination with, the ramp form, in accordance with again a further feature of the invention, the rings may have at least one depression for each roller body, the roller bodies engaging in the depressions at the same time in each case and a latching position of the door, thus, being defined.

To prevent the roller bodies from leaving that region of the rings that is assigned to them in each case, in accordance with again an added feature of the invention, measures for limiting the rotary movement freedom are, for example, a mechanical stop, provided expediently.

In the case of a top door bearing, which has to absorb substantially radial forces, in accordance with again an additional feature of the invention, the roller bearing is, expediently, configured as a radial bearing, in particular, as a needle bearing.

To define a latching position of the door, it is also possible for the door bearing to be provided with a closing body that can be moved under loading by a spring and can be brought into engagement with, or disengaged from, a counterpart by virtue of the door being rotated, the door being fixed in the latching position when the two are engaged and being fully rotatable when they are disengaged.

In accordance with yet an additional feature of the invention, a guide for the movement of the closing body is, preferably, fixed to a ring of the roller bearing. In particular, the ring and the guide may be connected to form a housing that eventually closes off the bearing in the outward direction.

In accordance with still another feature of the invention, the supporting arm may be provided with a projecting stop for securing its position on the doorframe. In such a case, it is expedient for the closing body to be disposed on a side of the stop that is directed away from the doorframe. This configuration results in the counterpart being as remote from the bearing journal as is possible on the supporting arm. As a result, the closing body and the counterpart, with a given configuration and strength of the spring, can subject the door to a relatively large torque.

With the objects of the invention in view, there is also provided a method of mounting a door on a door frame, having the following steps:

a) fastening a top and a bottom supporting arm on the door frame;

b) placing the door between the supporting arms;

c) inserting a bottom bearing journal through a bore of the bottom supporting arm into a bore of the door.

In accordance with still a further mode of the invention, a top bearing journal is inserted through a bore of the top supporting arm into a bore of the door.

In accordance with a concomitant mode of the invention, a top bearing journal is inserted through a bore of the top supporting arm and subsequently fitting a bore of the door over the top bearing journal when placing the door between the supporting arms.

Other features that are considered as characteristic for the invention are set forth in the appended claims.

Although the invention is illustrated and described herein as embodied in a door bearing and method of mounting a door, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, cross-sectional view through a bottom region of a doorframe and of a door of a refrigerator, the region being provided with a bottom door bearing according to the invention;

FIG. 2 a fragmentary, perspective view of the supporting arm of the door bearing of FIG. 1 with a bearing journal mounted thereon;

FIG. 3 a fragmentary, cross-sectional view through a top region of a doorframe of a refrigerator with a bearing journal according to the invention mounted thereon;

FIG. 4 is a perspective view of the bearing journal of FIG. 3;

FIG. 5 is a plan elevational view of the bearing arm of FIG. 3;

FIG. 6 is an enlarged, exploded, perspective view of a roller bearing that can be used for the door bearing of FIG. 1;

FIG. 7A is a fragmentary, enlarged, cross-sectional view along section line VII-VII in FIG. 6 with the rings in a first position;

FIG. 7B is a fragmentary, enlarged, cross-sectional view along section line VII-VII in FIG. 6 with the rings in a second different position than in FIG. 7A;

FIG. 8 is a fragmentary, enlarged, cross-sectional view analogous to that of FIGS. 7A and 7B through a second configuration of the roller bearing according to the invention;

FIG. 9 is a fragmentary, enlarged, cross-sectional view analogous to that of FIGS. 7A and 7B, through a third configuration of the roller bearing according to the invention;

FIG. 10 is a perspective view from above a roller-bearing ring with carry-along elements according to the invention; and

FIG. 11 is a fragmentary, partially hidden, cross-sectional view of a bottom supporting arm with roller bearing according to a further configuration of the invention.

### DESCRIPTION OF THE PREFERRED EMBODIMENTS

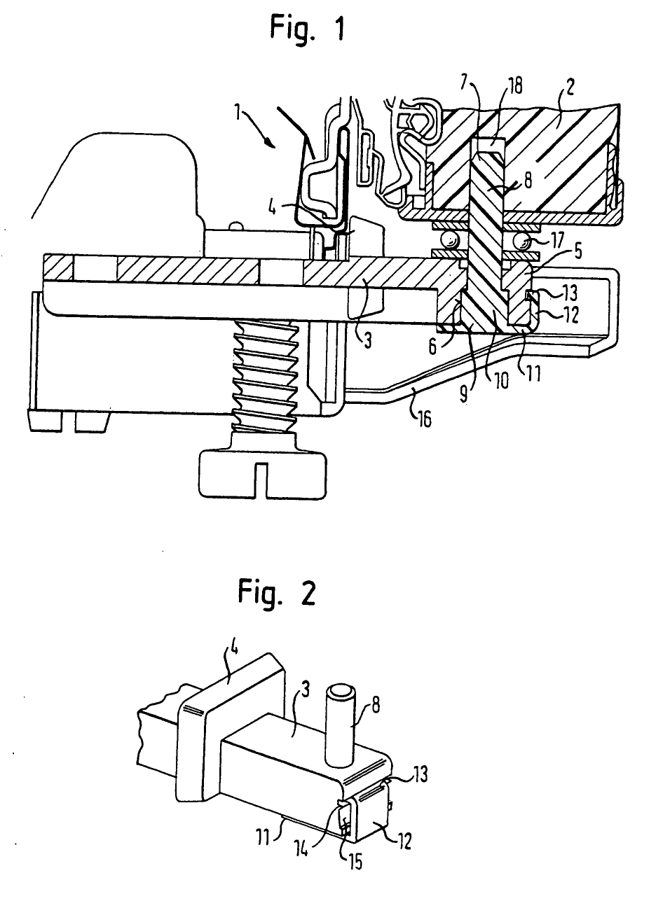

Referring now to the figures of the drawings in detail and first, particularly to FIG. 1 thereof, there is shown a vertical section through the bottom region of a door frame 1 and of the door 2 of a refrigerator. A substantially bar-like supporting arm is pushed through an opening on the front side of the door frame 1 into the housing of the refrigerator and fastened therein, e.g., by screw connection or latching. The supporting arm 3 is in the form of an upside-down-U profile over most of its length, and has a solid head portion 5 through which a bore 6 extends vertically. Integrally formed on that portion of the supporting arm 3 that is in the form of an upside-down U is a stop 4 that projects upward and to the sides and defines the depth to which the supporting arm 3 can be introduced into the opening of the housing.

A bearing journal 7 is accommodated in a form-fitting manner in the bore 6. The bearing journal 7 is made up of a pin 8, which projects upward beyond the supporting arm 3, and of a base portion 9. The base portion 9 is made up of a cylindrical portion 10, of which the diameter is somewhat larger than that of the pin 8, and of a clip 11, which, first of all, extends horizontally from the cylindrical portion 10 and, then, merges into a vertical leg 12 with an integrally formed nose 13 directed toward the cylindrical portion 10. The clip 11, in particular, its leg 12, is, inherently, flexible. As a result, when the bearing journal 7 is pushed into the bore 6 from beneath, the nose 13, in the first instance, can be moved away elastically outward in order, then, when the bearing journal 7 reaches its end position in the bore 6, to engage behind an edge 14 formed at the head end 5 of the supporting arm 3 (see FIG. 2) and, thus, to interlock the bearing journal 7.

An oblique surface 15 formed at the head end 5 of the supporting arm 3 is provided to make it easier for a tool, for example, a screwdriver, to be pushed in between the head end 5 and the clip 11 and, thus, to release the nose 13 from the edge 14 again. Once the release has been done, it is possible for the bearing journal 7 to be pulled downward out of the bore 6 and, then, for the door 2 to be removed.

The bearing journal 7 may be formed in one piece from a, preferably, fiber-reinforced plastic material. Such a material makes it possible, on one hand, for the pin 8 to be formed with a stiffness and strength sufficient for securing the door 2 but, on the other hand, to render the clip 11 flexible.

It is also possible, however, for just the base portion 9 to be formed from plastic and to be connected to a pin 8 made of metal to form the bearing journal 7. For example, the metallic pin 8 may be of such a length that it extends into the cylindrical portion 10, and the base portion 9, as a whole, is produced by partially encapsulating the pin 8 in the plastic material.

The head end of the supporting arm 3 and the base portion 9 are concealed behind a removable cover 16.

Disposed on the top side of the supporting arm 3, surrounding the pin 8, is a roller bearing 17, preferably, a ball bearing or, in particular, a barrel-like roller bearing. The roller bearing 17 bears most of the weight of the door 2. The pin 8 of the base portion 9, which engages in a blind bore 18 of the door 2, does not come into contact with the bottom of the bore 18 and, thus, substantially only absorbs forces in the radial direction.

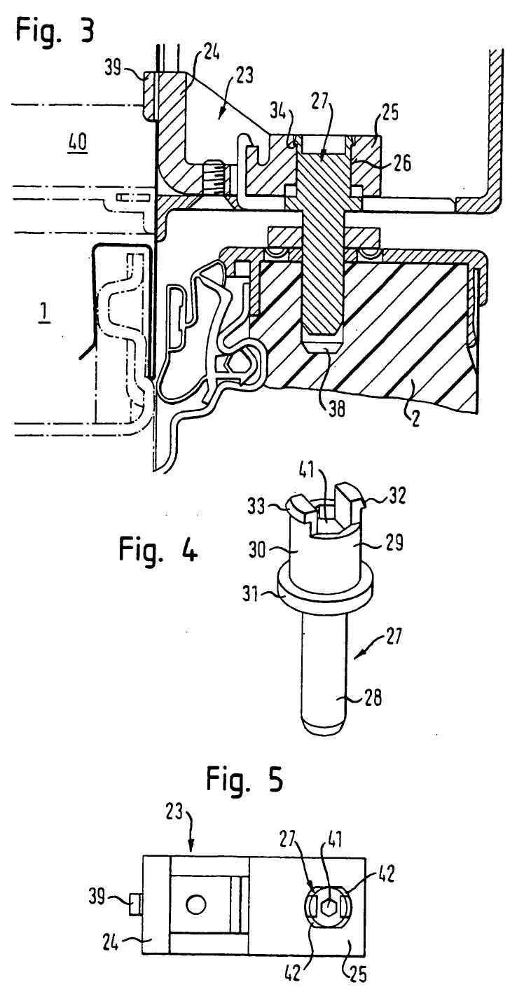

FIGS. 3, 4, and 5 show a top door bearing and the bearing journal thereof. FIG. 3 is a vertical section analogous to that of FIG. 1, this vertical section showing part of the doorframe 1 and the top end region of the door 2 with the door bearing connecting the two. The door bearing includes a supporting arm 23 with a head portion 25 and an abutment surface 24, which are connected to one another by a portion in the form of a U profile with the leg length of the U decreasing from the abutment surface 24 in the direction of the head portion 25. On its side that is directed toward the doorframe 1, the abutment surface 24 bears a hook 39 that, for the purpose of fastening the supporting arm 23, is, first of all, inserted through a pre-punched opening of the door frame 1 and, then, displaced upward. A screw connection between the supporting arm 23 and a subsequently fitted L profile 40 prevents the supporting arm 23 from sliding down and the hook 39 from coming free again.

A bearing journal 27 is shown introduced into a bore 26 of the head portion 25. As can be seen in FIG. 4, in particular, the bearing journal 27 is made up of a pin 28 and a base portion 29 for fastening in the bore 26. The base portion 29 includes a central cylindrical portion 30 that bears, in the bottom region, an encircling flange 31, and, in the top region, two elastically bendable legs 32 with integrally formed latching noses 33.

The pin 28 engages from above in a bore 38 of the door 2. Because, rather than bearing any load, it is only exposed to radial forces, a non-illustrated radial bearing, in particular, a needle bearing, may be introduced into the bore 38 between the pin 28 and door 2 to make the door 2 move smoothly.

Formed between the two legs 32 in the cylindrical portion 30 is a depression 41, which is provided for accommodating a hexagon socket wrench with a hexagonal cross section. It would also be possible, however, for the purpose of accommodating other types of screwdriver, for the depression to be configured, for example, as a straightforward slot or as a cross-slot. The point of this measure becomes clear upon looking at FIG. 5, which shows a plan view of the supporting arm 23 with the bearing journal 27 introduced into the bore 26. The bore 26 has been widened by cutouts 42 on two opposite sides, in the region of its top end, to give a non-round shape. These cutouts 42 form edges 34 (see FIG. 3), behind which the latching noses 33 of the bearing journal 27, which are pushed in from beneath in FIG. 3, interlock. If the bearing journal 27, however, is turned in the bore 26 with the aid of the abovementioned tool, it can be seen in FIG. 5 that the latching noses 33 are, then, forced back radially inward out of the cutouts 42. If the bearing journal 27 is turned through 90° counter to the orientation shown in FIG. 5, then the latching noses 33 are free and the bearing journal 27 can be pulled downward out of the bore 26.

In the case of the door 2 being mounted using the door bearings shown in FIGS. 1 and 3, the procedure may be as set forth in the following text.

In the first instance, the supporting arms 3, 23 are fitted on the door frame 1. The door 2 is, then, guided up to the door frame 1 from beneath. As a result, the pin 28 of the top door bearing 23 engages in the bore 38. While the door 2 is, then, secured on the door frame 1, the bearing journal 7 of the bottom door bearing is pushed through the bore 6 and into the bore 18 and latched.

As an alternative, it is possible to select for the top bearing a construction corresponding to that in FIG. 1, in which the bearing journal 7 is inserted from the side that is directed away from the door 2. This construction makes it possible, in the first instance, for the door 2 to be positioned on the previously mounted bearing journal 7 of the bottom door bearing and to be retained on the door frame 1 and, then, for the top bearing journal to be inserted, or for both bearing journals only to be inserted when the door 2 is retained in the desired position on the door frame 1.

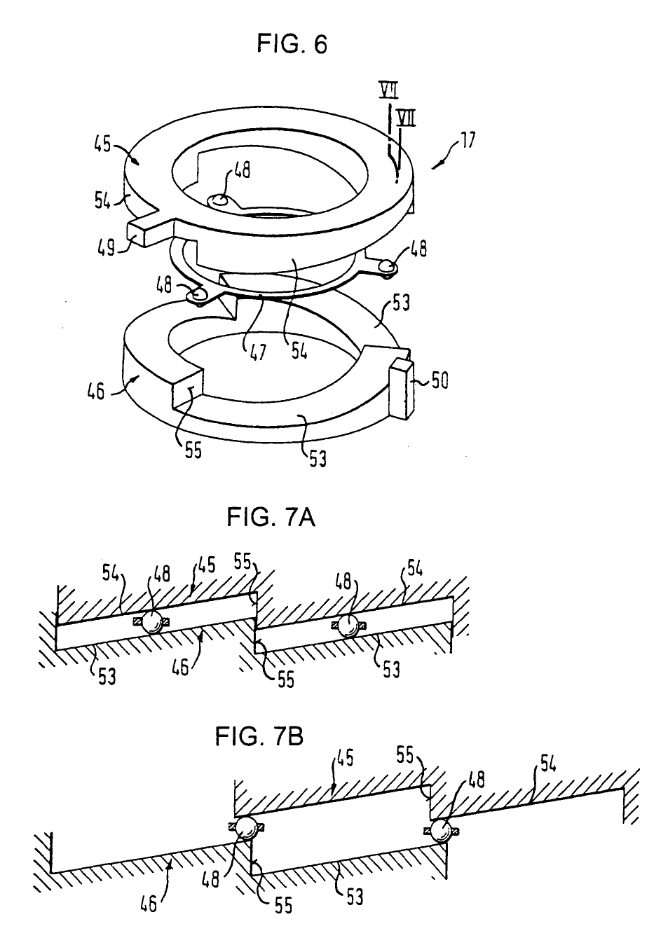

FIG. 6 shows an exploded perspective view of the first exemplary embodiment of a roller bearing that is suitable for the bottom door bearing of FIGS. 1 and 2. This roller bearing 17 is constructed as an axial bearing, with a top ring 45 and a bottom ring 46 and a cage 47 for retaining three ball-like or barrel-like roller bodies 48 between the rings 45, 46. On the mutually opposite sides, the rings 45, 46 have three ramp-like portions 53, 54, one for each roller body 48, each separated by vertical flanks 55. The two rings 45, 46 each bear a lateral protrusion 49, 50, the latter serving as a measure for limiting the rotary movement freedom by striking against one another when the top ring 45 rotates through somewhat less than 120° in the counter-clockwise direction out of the orientation shown in FIG. 6.

The functioning of the roller bearing 17 can be better understood with reference to FIGS. 7A and 7B, which shows two different rotary positions of the rings 45, 46 along section line VII-VII of the roller bearing from FIG. 6.

FIG. 7A shows a roller body 48 and a detail of the two rings 45, 46 in the lowest possible position, in which the vertical flanks 55 come into contact with one another at the end of the ramp-like portions 53, 54 of the top ring 45 and bottom ring 46. Such a position corresponds to the closed position of the door 2. The roller body 48 is located halfway up the mutually opposite ramps 53, 54 of the rings 45, 46. Rotating the ring 45 in the counter-clockwise direction (with respect to FIG. 6) causes the roller body 48 to move up the ramp 53 at half the speed of the top ring 45. When the roller body 48 reaches the vertex of the ramp 53 of the bottom ring 46 (i.e., the position shown in FIG. 7B), the protrusions 49 and 50 come into contact with one another. As a result, further rotation is prevented and the roller body 48 cannot reach the next-following ramp 53 of the ring 46. Such a position of the rings 45, 46 and roller body 48 corresponds to a fully open door 2. The opening angle of the door corresponds to 120° minus an amount that is determined by the extent of the roller body 48. If a user lets go of the door 2 in this open position, the roller bodies 48 roll down the ramps 53 again until they reach the position of FIG. 7A, in which the door is closed.

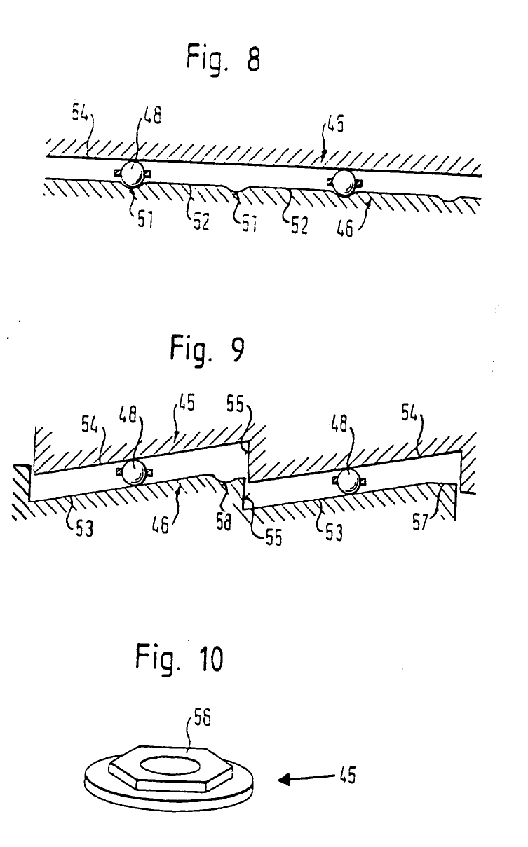

FIG. 8 shows a section through a second configuration of a roller bearing analogous to the section of FIGS. 7A and 7B. One of the rings, in this case the bottom ring 46, is subdivided by equidistant depressions 51 into a plurality of portions corresponding to the number of roller bodies. This number may be larger here than in the case of FIGS. 7A and 7B, possibly up to 6 and, preferably, 5. As in FIG. 7A, FIG. 8 illustrates a roller body 48 in a position that corresponds to the closed door 2 because the roller body 48 is located at the bottom of one of the depressions 51. When the door is rotated, and the top ring 45 begins to rotate relative to the bottom ring 46, the roller body 48, in the first instance, has to leave the depression 51 in order to reach a planar ring portion 52 between two depressions 51. Such movement requires the top ring 45 to be raised. As a result, the entire door 2 is raised. An initial resistance, thus, has to be overcome, first of all, to open the door. When the roller body 48 has reached the planar portion 52, the door 2 can be rotated with minimal friction to the extent where the roller body 48 reaches the vicinity of a second depression 51. If the roller body 48 enters into this second depression 51, then this corresponds to the door being latched in an open state. FIG. 8 shows every second depression 51 without a roller body, but it is possible for one to be assigned to each depression 51.

FIG. 9 shows a third roller bearing in a section analogous to FIGS. 7A, 7B, and 8. The rings 45, 46 of this roller bearing have substantially the same ramp-like profile as those from FIGS. 7A and 7B, albeit with the difference that the ramps 53 of the bottom ring 46 have a planar portion 57 at their top end, corresponding to the open state of the door. When, in the open state of the door, the roller bodies 48 are located on these planar portions 52, no restoring force acts on the door 2, and the maximum door opening state is, thus, stable. Instead of a planar portion 52, it is also possible to provide a concave portion 58.

It is important, in the case of the above-described types of roller bearing, for the rings 45, 46 not to be rotatable in relation to the supporting arm or the door. As is shown in FIG. 10, with reference to a perspective view of the top ring 45, the latter may bear, on its side that is directed away from the roller bodies 48, a carry-along element 56, in this case, in the form of a hexagonal protrusion, which engages in a rotationally fixed manner in a complementary cutout of the door or of the supporting arm.

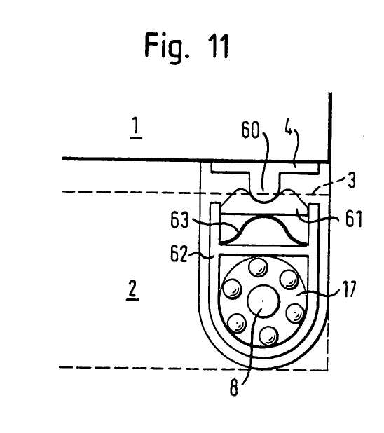

FIG. 11 shows a horizontal section through a further configuration of a bottom door bearing according to the invention. Elements that correspond to those of the bearing from FIG. 1 have the same designations. The section is taken level with the roller bearing 17 disposed between the supporting arm 3 and door 2. The roller bearing 17, here, is a conventional roller bearing with planar rings. The stop 4 has a rounded protrusion 60 that, in the position of the door bearing that is shown, engages in a recess of a closing body 61 and, thus, forms a counterpart to the latter. The closing body 61 can be displaced in a housing 62, counter to the force of a leaf spring 63, in the direction of the pin 8. The housing 62 is fixed to the top ring 45 of the roller bearing (not shown) or the door 2 and follows rotation of the door 2 as the latter is opened or closed. The door 2, which is illustrated by dashed outlines, is closed in the view of FIG. 11. When the door 2 is opened, the closing body 61 is displaced in front of the counterpart 60; at the same time, the closing body 61 is displaced, in its guide formed by the housing 62, in the direction of the pin 8, and the spring 63 is pressed flat. This results in a resistance having to be overcome when the door is opened and, conversely, in the door automatically closing from a partially opened state.

Once the door 2 has been opened to the extent where the closing body 61 and counterpart 60 are no longer in contact, the door can remain open in any desired position.

We claim:

1. A door bearing for a door having a door frame and defining a door bore, the door bearing comprising:
a bearing journal to be introduced into the door bore, said bearing journal having a base portion;
a supporting arm to be fastened to the door frame, said supporting arm defining a bore accommodating said base portion in a form-fitting manner; and
said base portion and said supporting arm having latching elements interlocking said bearing journal on said supporting arm.

2. The door bearing according to claim 1, further comprising:
a flexible clip having a movable leg moving away from said base portion when said base portion is pushed into said bore of said supporting arm;
said supporting arm having an edge, said movable leg having a nose engaging said edge when said base portion is pushed into said bore of said supporting arm; and
said latching elements being formed by said edge and a flexible clip.

3. The door bearing according to claim 2, wherein said nose is configured to be released from said edge by a tool introduced between said leg and said supporting arm.

4. The door bearing according to claim 1, wherein:
said bore has an axis and at least one cutout;
said base portion has at least one leg bent elastically in a direction of said axis of said bore when said base portion is pushed into said bore, said at least one leg having a nose engaging in said cutout when said base portion is pushed into said bore; and
said latching elements include said at least one cutout and said at least one leg.

5. The door bearing according to claim 4, wherein:
said bore has a circumference;
said cutout only extends over part of said circumference; and
said base portion rotates in said bore to displace said nose out of said cutout.

6. The door bearing according to claim 5, wherein said base portion has:
an end directed away from said bearing journal; and
a depression for accommodating a turning tool in a form-fitting manner at said end.

7. The door bearing according to claim 1, wherein said bearing journal and said base portion are formed in one piece from a plastic material.

8. The door bearing according to claim 1, wherein said bearing journal has a metallic pin and a plastic base portion fixed together.

9. The door bearing according to claim 1, wherein said base portion is plastic and said bearing journal has a metallic pin fixed to said plastic base portion.

10. The door bearing according to claim 1, wherein said supporting arm is of a plastic material.

11. The door bearing according to claim 1, further comprising a roller bearing disposed around said bearing journal for supporting the door.

12. The door bearing according to claim 11, wherein:
the door bearing is a bottom door bearing: and
said roller bearing is an axial bearing.

13. The door bearing according to claim 12, wherein said axial bearing is a barrel-shaped roller bearing.

14. The door bearing according to claim 11, wherein said roller bearing has:
rings with ramp-shaped ring portions; and
roller bodies running on said rings, each of said roller bodies being associated with one of said ramp-shaped ring portions.

15. The door bearing according to claim 11, wherein said roller bearing has:
at least one ring with at least one depression; and
roller bodies running on said at least one ring, said at least one ring having at least one depression for each of said roller bodies.

16. The door bearing according to claim 14, further comprising means for limiting rotary movement freedom of said roller bodies limiting rotary movement of said roller bodies to have at most one of said roller bodies reach a given point of said rings.

17. The door bearing according to claim 15, further comprising means for limiting rotary movement freedom of said roller bodies limiting rotary movement of said roller bodies to have at most one of said roller bodies reach a given point of said rings.

18. The door bearing according to claim 14, further comprising a limiting device limiting rotary movement of said roller bodies to have at most one of said roller bodies reach a given point of said rings.

19. The door bearing according to claim 15, further comprising a limiting device limiting rotary movement of said roller bodies to have at most one of said roller bodies reach a given point of said rings.

20. The door bearing according to claim 11, wherein:
the door bearing is a top door bearing; and
said roller bearing is a radial bearing.

21. The door bearing according to claim 20, wherein said radial bearing is a needle bearing.

22. The door bearing according to claim 1, further comprising:
a spring;
a counterpart; and
a closing body moved under loading by said spring, said closing body being brought into engagement with or disengaged from said counterpart by rotation of the door, said closing body and said counterpart fixing the door in position when said closing body and said counterpart are engaged and permitting the door to be fully rotatable when said closing body and said counterpart are disengaged.

23. The door bearing according to claim 11, further comprising:
a spring;
a counterpart;
a closing body moved under loading by said spring, said closing body being brought into engagement with or disengaged from said counterpart by rotation of the door, said closing body and said counterpart fixing the door in position when said closing body and said counterpart are engaged and permitting the door to be fully rotatable when said closing body and said counterpart are disengaged;
said roller bearing having a ring; and
a guide for guiding movement of said closing body fixed to said ring of said roller bearing.

24. The door bearing according to claim 23, wherein:
said supporting arm has a projecting stop for defining a position of said supporting arm on the door frame, said stop having a side directed away from the door frame; and
said counterpart is disposed on said side of said stop.

25. A method of mounting a door on a door frame, which comprises:
fastening a top and a bottom supporting arm on the door frame;
placing the door between the supporting arms; and
inserting a bottom bearing journal through a bore of the bottom supporting arm into a bore of the door.

26. The method according to claim 25, which further comprises inserting a top bearing journal through a bore of the top supporting arm into a bore of the door.

27. The method according to claim 25, which further comprises inserting a top bearing journal through a bore of the top supporting arm and subsequently fitting a bore of the door over the top bearing journal when placing the door between the supporting arms.

28. A method of mounting a door on a door frame, which comprises:
a) fastening a top and a bottom supporting arm on the door frame;
b) placing the door between the supporting arms; and
c) inserting a bottom bearing journal through a bore of the bottom supporting arm into a bore of the door.

29. The method according to claim 28, which further comprises:
d) inserting a top bearing journal through a bore of the top supporting arm into a bore of the door.

30. The method according to claim 28, which further comprises:
d) inserting a top bearing journal through a bore of the top supporting arm and then fitting a bore of the door over the top bearing journal in step b).
